(19) United States
(12) Patent Application Publication
(10) Pub. No.: US 2005/0060687 A1
(43) Pub. Date: Mar. 17, 2005

(54) Method and apparatus for documenting and describing object oriented programming logic

(76) Inventors: David Abu Ghazaleh, Apex, NC (US); Michael Frank, Raleigh, NC (US); James Edward Shivers, Efland, NC (US); John Daniel Griffin, Durham, NC (US)

Correspondence Address: Theodore Naccarella, Esquire;Synnestvedt & Lechner LLP, 2600 Aramark Tower, 1101 Market Street, Philadelphia, PA, 19107-2950, US

(21) Appl. No.: 10/663,455

(22) Filed: Sep. 15, 2003

(51) Int. Cl. G06F 9/44

(52) U.S. Cl. 717/123

(57) ABSTRACT

The invention is a method and apparatus for defining, representing, and/or documenting object oriented programming applications, and particularly, those developed to work in a graphical user interface. The invention represents the applications in one or more diagrams termed Object and Event Diagrams (OEDs). The invention allows an application architect to communicate the program idea to the programmer by defining the program basis and the program logic without concern about details of the user interface such as how actions will be executed (which will be determined by the programmer). The OED may be used as a program specification, a program requirements description or as a documentation tool to document the logic of the object and event used in a program. The application architect represents the program in an OED using a plurality of different types of symbols that represent different types of objects and other program elements, such as data transfer, inheritance and remote links. The various symbols are interconnected by lines that show their relationships to each other.

### FIELD OF THE INVENTION

The invention pertains to the documentation and description of object oriented programming logic, particularly in connection with fourth and fifth generation object oriented programming languages.

### BACKGROUND OF THE INVENTION

Traditionally, a computer program was viewed as a logical procedure that takes input data, processes it, and produces output data. The process of developing a software routine was seen as a process of determining how to write the logic to achieve the desired actions. Object oriented programming (OOP) was a revolutionary concept that changed the paradigm for computer software development by taking the view that computer programming should be organized around objects rather than actions, i.e., data rather than logic. Today, most software development is performed in object oriented programming languages (OOPLs). C++ and Java are among the most popular object oriented programming languages today. The Java programming language is designed especially for use in distributed applications on corporate networks and the Internet.

In object oriented programming, an object is any data structure with a defined intent that is capable of executing a logical sequence of commands. An object can represent virtually anything, such as a person (e.g., described by name, address and/or other information) or a room (the properties of which can be described by attributes, such as its length, width, furnishings, wall color, floor type, etc.) or elements of a graphical user interface (GUI) such as buttons, scroll bars, pull down menus, windows, etc.

In object oriented programming, the first step is to identify all objects that one may wish to manipulate and how they relate to each other. This process is known as data modeling. The actual data that defines a particular object such as the aforementioned name, address, length, width, color, furnishings, etc., are called its attributes. An attribute essentially is a changeable property or characteristic of an object that can be set to different values. Once an object has been identified, it is generalized as a “class” of object. The class defines the kind of data (e.g., attributes) that objects of that class contain and any logic sequences, e.g., methods, that can manipulate it. Accordingly, a class basically is a template definition of the methods and variables/attributes of a particular type of object. Thus, an object is a specific instance of a class, i.e., it contains actual attribute values instead of variables. Each distinct logic sequence is known as a method. A method is a programmed procedure that is defined as part of a class and included in any object of that class. A class (and thus an object) can have more than one method. A method in an object can only have access to the data known to that object, which ensures data integrity among the set of objects in an application. A method can be re-used in multiple objects.

The object (sometimes called a class instance) is what is run on a computer. Its methods provide computer instructions and the class object characteristics provide relevant data. A human operator communicates with objects—and they communicate with each other—via well-defined interfaces called messages.

In object oriented programming, an event is anything that occurs that causes a piece of code to be executed. Accordingly, an event can be a human user input event, such as clicking on a button or a hyperlink, or program driven, such as when one piece of code performs some function that results in another piece of code being executed.

The concept of a data class makes it possible to define subclasses of data objects that share some or all of the main class characteristics. Called inheritance, this property of OOP forces a more thorough data analysis, reduces development time, and insures more accurate coding.

Software programs can be represented at many levels of detail, such as object code, source code, and higher levels of representation. Object code (or machine code) essentially is numerical data that the actual processor understands. Object code is what is known as a first-generation programming language, or 1GL. Assembly language (example instruction: add 12, 8) is called second-generation language or 2GL. 3GL or third-generation language is a high level programming language, such as PL/I, C, or Java and may or may not be an OOPL. A compiler converts the statements of the specific high-level programming language into machine language. A 4GL or fourth-generation language is designed to be closer to natural language than a 3GL language. 5GL or fifth-generation language is programming that uses a visual or graphical development interface to create source language that is usually compiled with a 3GL or 4GL language compiler.

Some companies, including International Business Machines Corporation, make 5GL visual programming products for developing applications in Java, for example. Visual programming allows a software developer to easily envision object oriented programming class hierarchies and drag and drop icons to assemble program components.

In the field of software development, a software developer, systems analyst, or program architect (hereinafter “architect”) typically prepares a specification describing at a higher level than the actual code level the software that is to be developed and provides that information to a programmer (or coder) who writes the actual software in source code. In traditional (i.e., non-OOP) programming, a software architect may have described the desired software in terms of a flow chart which comprises a series of steps (i.e., actions) in some sequence. Flow charts, however, are not particularly well-adapted to representing object oriented programming because, as previously mentioned, object oriented programming focuses on objects rather than actions.

Software tools particularly adapted for object oriented programming languages are available today that are designed to allow a software architect to describe the software at a high level so that the software architect can work more efficiently by concentrating on the business or other logic without getting bogged down in the actual computer science of writing code.

However, the available methods and tools are not as efficient as could be in terms of assisting a software architect in defining, representing, and documenting OOP applications, particularly applications developed to work in a graphical user interface.

Therefore, it is an object of the present invention to provide a method and apparatus for describing object oriented programming at a high level that is easy to use and intuitive in nature.

### SUMMARY OF THE INVENTION

The invention is a method and apparatus for defining, representing, and documenting object oriented programming applications, and particularly, those developed to work in a graphical user interface. The invention represents the applications in one or more diagrams that we term Objects and Events Diagrams (OEDs). The invention allows an application architect to communicate the program idea to the programmer by defining the program basis and the program logic without concern about programming-level details of the program, such as how actions will be executed or in which event actions will take place (which will be determined by the programmer). The OEDs may be used as a program specification or a program requirement description. Alternately, they can be used as a documentation tool to document the logic of the objects and events used in a program.

In the present invention, the application architect represents a program or program portion with an OED using a plurality of different types of symbols that represent different types of objects, as well as a few additional informative symbols that represent some other significant program elements such as data transfer, inheritance, remote links, and databases. The OED also interconnects the various symbols to show their relationships to each other. The architect can place text within the various symbols or in separate documentation to define attributes of the objects and/or other specific details of the object represented by the symbol.

The invention can be practiced manually (e.g., with pencil and paper). Alternately, the invention can be embodied in software. In such software, the user is presented with a graphical user interface within which the user can drag and drop the various symbols from one or more menus or pallets onto a work area and interconnect them and fill in the object attribute and other data textually and/or through other GUI tools.

### BRIEF DESCRIPTION OF THE DRAWINGS

FIG. 1 shows the various symbols that are available for use in an objects and events diagram in accordance with one particular embodiment of the invention.

FIG. 2 is an exemplary graphical user interface application comprising two windows that can be defined, represented, and/or documented by an objects and events diagram in accordance with the present invention.

FIG. 3 is a portion of the graphical user interface shown in FIG. 2 corresponding to the first window of the two windows.

FIG. 4 is a portion of the graphical user interface shown in FIG. 2 corresponding to the second of the two windows.

FIG. 5 is an objects and events diagram in accordance with the present invention documenting the first window shown in FIGS. 2 and 3.

FIG. 6 is an objects and events diagram in accordance with the present invention documenting the second window shown in FIGS. 2 and 4.

FIG. 7 is an objects and events diagram in accordance with the present invention documenting in more detail the flights table object shown in FIG. 6.

FIG. 8 is a system-level objects and events diagram documenting the overall website of which the web page represented in FIG. 2 is a part.

### DETAILED DESCRIPTION OF THE INVENTION

The present invention is a method, process and/or product that aids in the definition, representation and documentation of object oriented programming applications, particularly, those developed to work in a graphical user interface. The invention represents an object oriented programming language application in one or more diagrams that we term objects and events diagrams or OEDs. The invention is not intended to be limited to any particular embodiment or execution paradigm. For instance, the invention and, particularly, OED diagrams can be prepared by hand by an application architect. Alternatively, the invention can be implemented through a computer program that presents a GUI to the application architect through which he can build an OED, such as by dragging and dropping elements from one or more pallets. Even further, an invention can be incorporated as part of a 5GL programming language in which the user creates an OED through a software GUI and the 5GL program generates code from the OED.

In accordance with the invention, a plurality of standardized symbols, each different symbol representing a different type of object or other programming element, is available for use. In some embodiments of the invention, the library of symbols can be made extensible by the user, i.e., the user can add his or her own symbols. Further, a set of rules define how the symbols are to be used to develop OEDs. In addition, there are recommendations for using the symbols to create an OED. Recommendations generally are instructions as to how to use the symbols in an OED, but, unlike rules, do not require strict adherence. Described below are one or more particular embodiments of the invention. It is to be understood that any rule discussed below could be merely a recommendation in another embodiment and vice versa (i.e., any recommendation may be a rule in another embodiment).

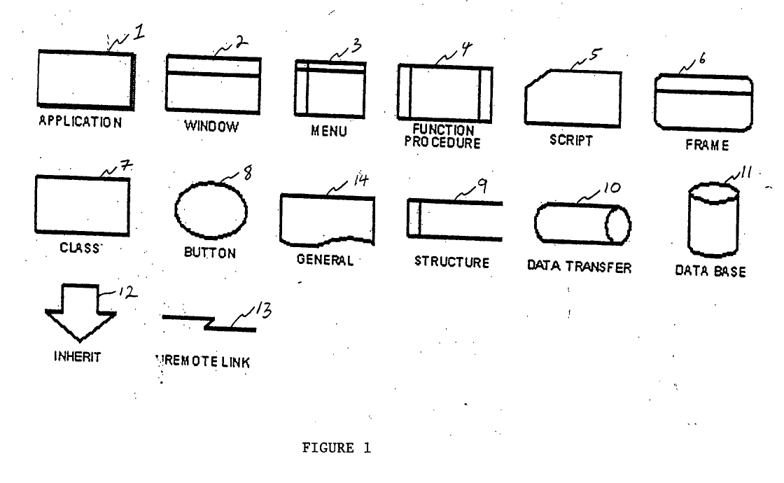

FIG. 1 illustrates the object symbols in accordance with one particular embodiment of the invention. Each symbol represents a different type of object or other significant programming element as will be discussed in greater detail below. However, before describing each of the symbols of this particular embodiment, a general discussion of objects is in order. As discussed above, an object can be almost anything that can be coded into computer instructions. An object may be defined as any data structure with a defined intent that is capable of being represented by a logical sequence of computer commands. Furthermore, all objects are at least one of the following four types:
1. an object defined within another object;
2. an object assigned to another object;
3. a static object; and
4. a dynamic object.
   An object can simultaneously be more than one of these four types of objects. However, an object can be either a static object or a dynamic object, but not both. As will become clear from the discussion below, generally, an object will either be static or dynamic. Furthermore, an object can be either an object assigned to another object or an object defined within another object but not both.

Referring now to FIG. 1, symbol 1 is used to represent an application, project, or system type object (hereinafter application). These three terms are intended to define the same thing and are not intended to be three different things. Within the relevant professional fields, these terms are generally used interchangeably to refer to an overall computer program. This symbol may be used to represent the most general objects in a computer program. For instance, it may be used to represent the overall program. It also may be used to represent windows, reports, menus, classes, and methods. An application object 1 is a dynamic object and commonly will be neither defined within another object or assigned to another object.

Symbol 2 is used to represent a window or form type object such as a window in a graphical user interface. (Note that, in the JAVA programming language, a window is called a form.) In accordance with the terminology of the present application, a window is a user interface that contains a set of objects that can execute rules. A window generally is in the top level of the user interface of an application. A window object generally is a dynamic object because, at a minimum, it will have another object defined within or assigned to it. For example, even a window that comprises nothing but a single graphic file still would be a dynamic object in accordance with the terminology as defined hereinabove. The graphic file, on the other hand, would be a static object as it has no logic, rule, event, script or other object assigned to it.

Merely as an example, in a business application for an e-commerce retailers website, one class object may be called “customer” wherein its attributes, methods and functions define what information can be entered about a customer of the retailer (e.g., name, address, telephone number and what can be done with respect to a customer object, e.g., it can be added, deleted, or modified). A class object generally will be a dynamic object. However, a class may have only attributes and no methods, in which case it would be static. A class generally will not be defined within another object or assigned to another object.

Symbol 3 represents a menu-type object. It may be used to represent a menu bar, a menu, an item in a menu, or a menu option depending on the desired level of detail for the diagram. A menu is a list of options and commands from which a user can choose one option or command. Again, anyone familiar with graphical user interface programming languages such as Java and HTML is familiar with the concept of menus, menu bars (a collection of menus) and menu items or options. A menu-type object almost always is a dynamic object and is an object assigned to another object. For instance, an object menu does not depend on any other object to exist, but in order for a menu to be useful in most cases, it must be assigned to an object window.

Symbol 4 represents function/procedure/method type objects (hereinafter “methods”). A method is a well known concept of object oriented programming languages and, therefore, does not warrant a detailed discussion herein. As will be discussed in greater detail below, a method symbol in an OED of the present invention does not represent a call to a method. Instead, it represents the fact that the method is available to the object to which it is assigned. A method object is a dynamic object. Further, it is an object assigned to another object. Particularly, it is not an object defined within another object as it does not require another object for its definition, but generally will be of no use unless it is assigned to another object, such as an application (in which case it can be available to any other object in the application) or a window or a menu.

Symbol 5 represents an event script type object. An event script is code that is executed when an event associated with an object (e.g., clicking on a button) occurs that causes another piece of code to be run. Particularly, when the event occurs, the event script is executed, which, in turn, causes another module of code to run. Therefore, an event script object is a dynamic object as well as an object assigned to another object.

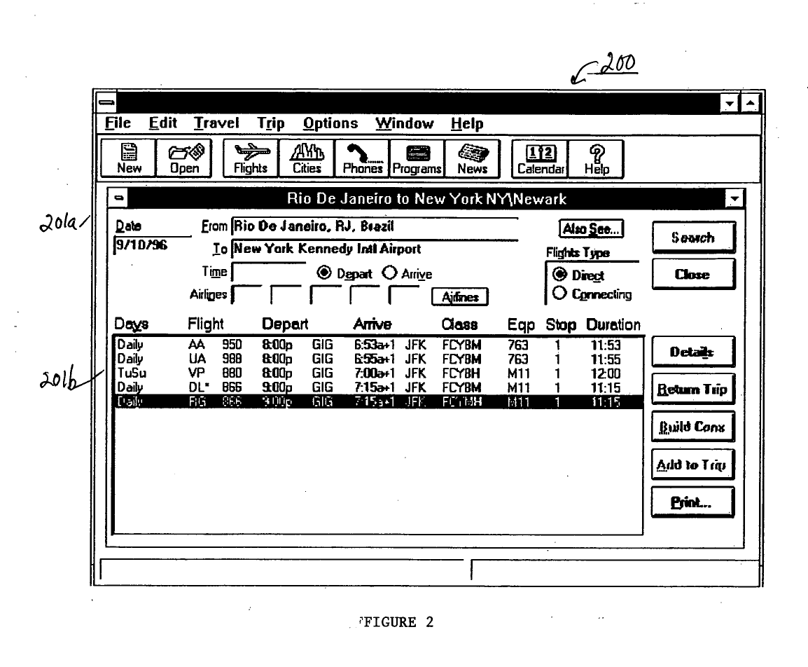

Symbol 6 represents a frame or report type object (hereinafter “a frame object”). A frame object is an interface used to display the results of a query, a formatted report, or a set of fields used to accept input from a user. A frame is usually defined within an object window and, therefore, usually is an object defined within another object. Also, it is a dynamic object. With brief reference to FIG. 2, which shows a web page, the rectangular box within which the information regarding various flight options is shown is a frame. Particularly, it contains data which is retrieved from a database as a result of a query. For example, in FIG. 2, the query was to identify available flights from Rio de Janeiro to New York City. Frames can be relatively complex objects. Formatted data reports are presented within frames. The user interfacing with the program can select data items within a frame and such selections can lead to actions being taken (e.g., an event script or method being executed).

Symbol 7 represents a class type object. A “class” is a well known element of object oriented programming and has previously been discussed herein and, therefore, will not be described in detail. Briefly, it is a category of objects. A class object defines a set of attributes, functions and methods for objects of that class. It is a general definition of objects of that class. As noted in the background section, a class defines its elements, e.g., attributes, functions and methods, as variables and an actual object is a particular instance of a class.

Symbol 8 represents a button type object. It represents a button. Once again, button objects are well known to anyone familiar with graphical user interfaces. Types of buttons include option buttons, check buttons, and picture buttons. A button is a dynamic object as it usually will have an event script attached to it (i.e., something happens when you click the button). Further, a button generally will be an object defined within another object. Particularly, a button generally will be of no use unless it is in a window.

Symbol 9 represents a data structure or record type object. Again, the concept of a structure or record is well known. It is a standard feature of the C++ programming language, for instance. Generally, a data structure is a definition of a structure of data, e.g., field: name (string), field: age (integer), field: address (string). For instance, referring to FIG. 2, each flight in frame 209 (i.e., line 209a in frame 209 is a populated record (or data structure). A data structure object is a static object. It can be assigned to another object, defined within another object or neither.

The next four symbols 10, 11, 12, 13 shown in FIG. 1 are informative symbols that do not represent objects, but other significant types of program aspects or elements in object oriented programming.

Symbol 10 represents data transfer. More specifically, symbol 10 represents data being transferred from one place to another. An example would be a socket connection between two objects for the purpose of transferring data there between. Thus, data transfer objects represent a relationship between two other objects, i.e., the two objects between which data is being transferred.

Symbol 11 represents a connection with a database. Assignment of a database to a window or other object means that the window can access the database. A database can be generally assigned to the whole application, in which case it would be assigned to the highest level application OED. Databases generally will not be defined within another object, as databases generally exist on their own and do not require another object to exist. However, they generally will not be useful unless they are assigned to another object, i.e., are available for use by another object.

Symbol 12 represents inheritance. Once again, inheritance is a well known aspect of object oriented programming and was previously discussed and, therefore, will not be described in detail herein. In brief, an object will inherit the attributes, methods, and functions of its parent class, for instance, which will be represented by this symbol drawn between the class object and the object that inherits that class' properties. Inheritance is not an object per se nor is it aptly categorized as either assigned to or defined within an object. Instead, inheritance, by definition, is a relationship between two other objects.

Symbol 13 represents a remote link between two objects. Remote links may be links between two applications. For example, RMIs (Remote Method Invocations) and RPCs (Remote Procedure Calls) are well known remote links in the Java programming language. A remote link is different from a data transfer in that a data transfer pertains to the transfer of data between two objects, whereas a remote link pertains to the invocation of a method in a different machine or object. It encompasses remote procedure calls and remote method invocations. Like inheritance and data transfer objects, a remote link is not an object per se nor is it aptly categorized as assigned to or defined within an object, as they represent accessibility of methods between two objects.

Finally, Symbol 14 is a generic symbol that represents all other types of objects not represented by one of the symbols 1-13. Generally, although not necessarily, it is used to represent static objects such as static text, single-line edits, multi-line edits, edit marks, list boxes, drop-down boxes, group boxes, labels, graphics, animations, etc.

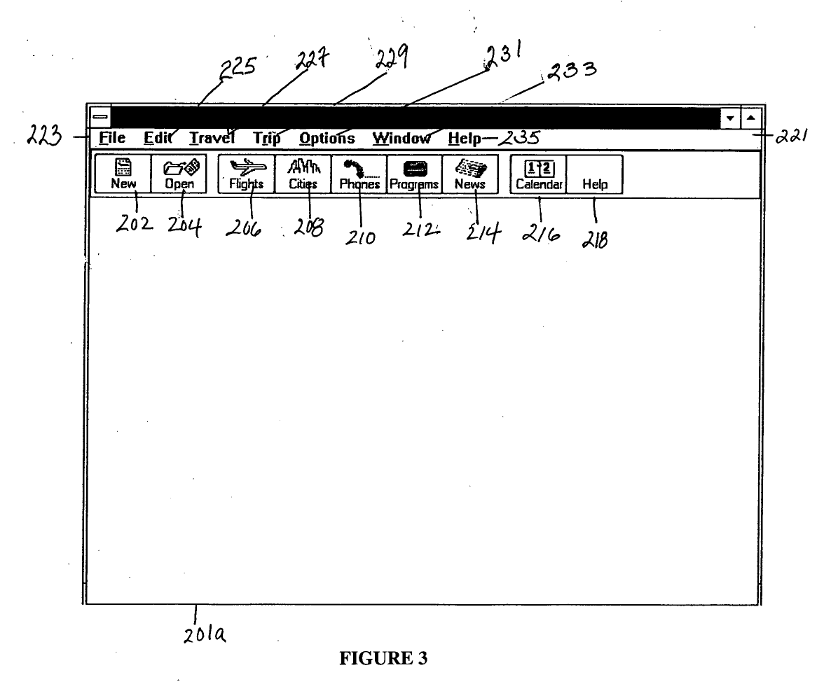

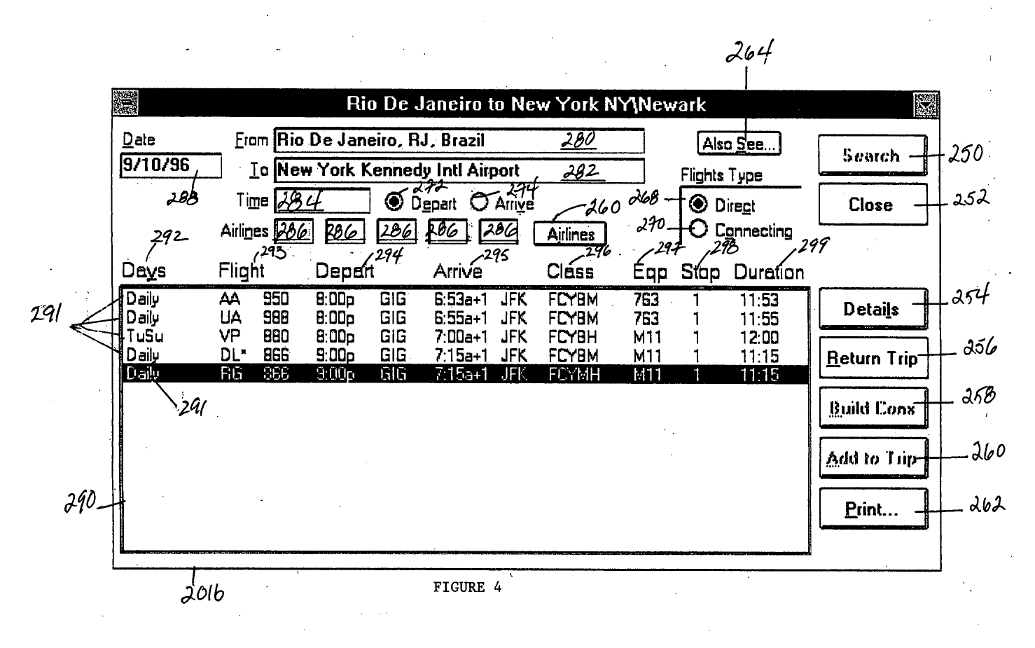

Having defined the object and other symbols in accordance with one particular embodiment of the invention, let us now refer to a specific example of use of the present invention to document an application in an OED. FIG. 2 is a graphical user interface, and, particularly, a web page, generated by an application that one might find in a typical business website. Particularly, FIG. 2 is a web page 200 that one might find on a travel service website with which a user can interface in order to find and book airplane flights. The web page comprises two windows, a main, “FLIGHTS” window 201a and a “FLIGHTS RESULTS” window 201b. FIG. 3 shows the main FLIGHTS window 201a disembodied from the web page 200 while FIG. 4 shows the FLIGHT RESULTS window 201b disembodied from the web page. The FLIGHTS RESULTS window 201b fits within the main FLIGHTS window 201a in the web page 200.

The web page 200 could just as readily have been composed as a single window containing the exact same elements. However, as is often the case with web sites and other applications, many, if not all, of the pages of a website or display screens (i.e., GUIs) of an application have identical primary components, such as the menu bar at the top, the title bar at the top, one or more tool bars, etc. Therefore, it often makes sense to code as a separate window a “main” window that can be re-used in all (or many) of the web pages and then code the more specific or unique portions of each web page (or other GUI) as a separate window to appear within the main window.

As can be seen in the Figures, there are a number of buttons that the user may click upon in both windows 201a and 201b in order to cause something to occur. Referring first to the main window 201a (FIG. 3), for instance, it includes the following buttons; NEW button 202, OPEN button 204, FLIGHTS button 206, CITIES button 208, PHONES button 210, PROGRAMS button 212, NEWS button 214, CALENDAR button 216, and HELP button 218. The window also includes a menu bar 221 including typical menus, e.g., FILE menu 222, EDIT menu 225, TRAVEL menu 227, TRIP menu 229, OPTIONS menu 231, WINDOW menu 233, and HELP menu 235.

The FLIGHTS RESULTS window 201b is shown in FIG. 4 disembodied from the web page 200 and includes another set of buttons, including: SEARCH button 250, CLOSE button 252, DETAILS button 254, RETURN TRIP button 256, BUILD CONNECTION button 258, ADD TO TRIP button 260, PRINT button 262, SEE ALSO button 264, AIRLINES button 266, DIRECT button 268, CONNECTING button 270, DEPART button 272, and ARRIVE button 274. There is a frame 290 in which flight information records 292 are displayed responsive to a customer's particular query. It further includes one or more text boxes, “FROM” box 280, “TO” box 282, “TIME” box 284, “AIRLINES” boxes 286, and “DATE” box 288. Other items in the flights results window 201b include static items, such as the text above the flight information frame, i.e., DAYS text 292, FLIGHT text 293, DEPART text 294, ARRIVE text 295, CLASS text 296, EQP text 297, STOP text 298, and DURATION text 299.

One familiar with typical e-business web pages can readily imagine the programming that might be associated with the various buttons, menus, frames, records and boxes on the web page 200 and, therefore, they will not be discussed in detail. In any event, as will become clear, the details of the actual programming associated with these objects in large part are not represented in the OED and are not crucial to an understanding of the present invention. The actual programming can be described in documentation separate from the OED, as discussed in more detail below.

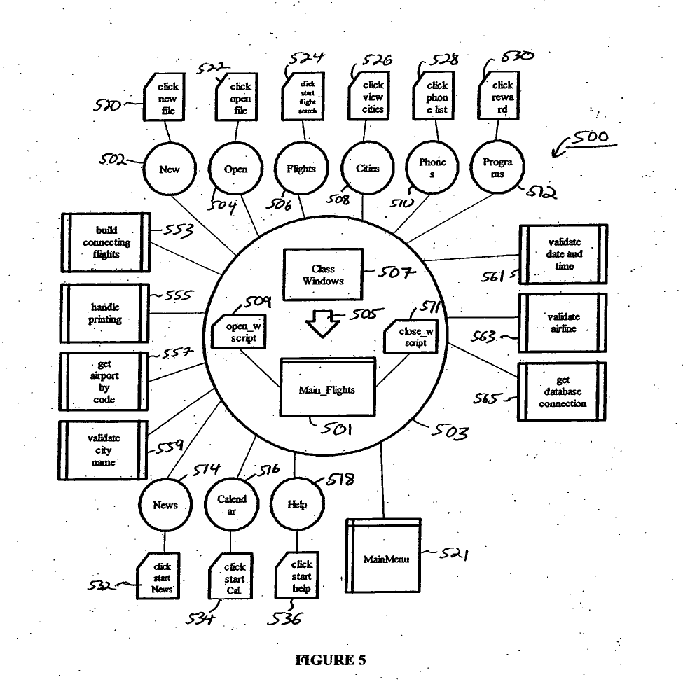

The OEDs of the present invention have many uses. They may be used to document pre-existing software. Alternately, they may be used during software development as a means for a business logic software developer (architect) to describe the business logic of a GUI application at a high level without defining the appearance of the actual GUI programming elements, which details are left to the GUI programmer who actually generates the code. Accordingly, in one use, the web page 200 (comprising windows 201a and 201b) can pre-exist the OEDs and OEDs can be created for windows 201a and 201b from the web page (or, for that matter, from the code that generates the windows). Alternately, the OEDs can be created by an application architect and given to a programmer who will write the code for generating the windows based on the OEDs. This frees the business logic architect from having to be concerned with the presentation logic. Likewise, it provides the GUI programmer with all the information about the business logic necessary to build the GUI, but gives him total freedom to develop the “look and feel” of the interface. Thus, both the business logic architect and the GUI programmer can concentrate on the area of their specific expertise without being concerned about the other aspects of the application program. FIG. 5 is an OED in accordance with the present invention diagram corresponding to the FLIGHTS window 201a shown in FIGS. 2 and 3 and FIG. 6 is an OED diagram in accordance with the present invention corresponding to the FLIGHTS RESULTS window 201b shown in FIGS. 2 and 4.

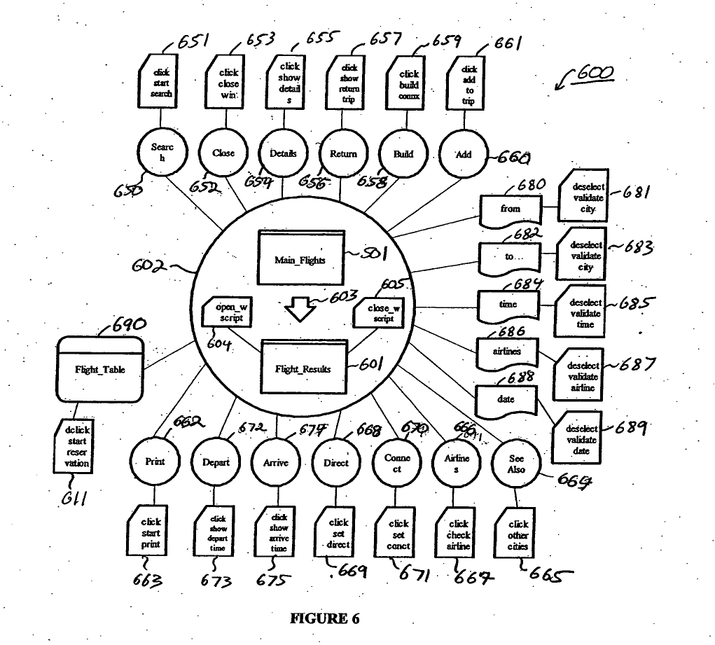

Before describing the OEDs shown in FIGS. 5 and 6, a description of at least one particular exemplary set of rules and recommendations for preparing OEDs in accordance with one embodiment of the invention using the symbol library shown in FIG. 1 is appropriate.

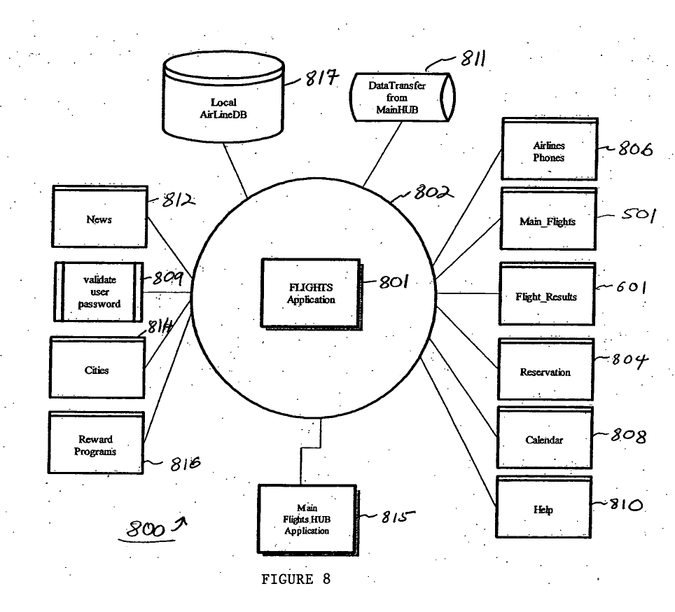

Each OED should have a particular main object. For any given application, any object sufficiently complex to require specific description in order to properly to enable a programmer to write the desired code or sufficiently complex to warrant separate documentation after written using traditional criteria and common sense should have its own OED. The main object of an OED may be almost any object type, but most often will be higher level dynamic object such as a window, as illustrated in each of FIGS. 5 and 6, or an overall system, application or project (i.e., an application object), as illustrated in FIG. 8 to be discussed further below. Since such objects tend to be complicated, i.e., have many other objects associated therewith or defined there within. On the other hand, static objects, such as buttons and data structures, and lower level dynamic objects, such as scripts often are quite simple and/or self-explanatory so that they do not require a separate OED.

In a preferred embodiment of the invention, the OEDs are never used to represent program calls. Thus, linking a method object to a window object in an OED does not mean that the window will call that method. Rather, it means that the method is available in that window and any event script assigned to the window or to another object within the window object can invoke that method.

The preparer of the OED (let us assume it is a program architect preparing an OED for use by a programmer in generating GUI code) should start an OED by drawing (or dragging and dropping in the case of a software implementation of the invention) the main object of the particular OED, whether it is an application, a window or something else. The architect should then place a circle around it. The object with the circle around it will be called the main object and it is the object that is being defined in that particular OED. In a preferred embodiment, any inheritance of the main object is represented within the big circle.

Referring to FIG. 5, for example, it shows an OED 501a describing the main FLIGHTS window 201a shown in FIG. 3 of the web page 200 of FIG. 2. As noted above, this exact window may be used in a number of the pages of the web site. The main flights window OED 500a is developed by first drawing a window object symbol 501. Next, a big circle 503 is drawn around window symbol 501 to define it as the main object of OED 500. Preferably, inheritance is represented within the big circle 503. Accordingly, inheritance symbol 505 and the class that is the source of the inherited characteristics is drawn within the circle 503. In this case, the source is the class “windows”, and it is represented by a class symbol 507. The inheritance symbol 505 should be drawn between the object inheriting the features, namely, window object 501, and the object from which it is inheriting those features, namely, class object 507, with the arrow pointing toward the object that is inheriting the features. Event scripts that are executed upon the opening or closing of the main object, i.e., the FLIGHTS window 501, also may be placed within the big circle 503. In this particular example, there is a script for each of those events and they are represented in the drawing by script symbols 509 and 511 corresponding to scripts executed upon opening and closing, respectively, of the FLIGHTS window 501. The SCRIPTS 509 and 511 are connected by a simple line to the object to which they are assigned. Event script symbols such as symbols 509 and 511 in FIG. 5 do not represent the code module, e.g., method, that is invoked by the script. They represent the script. The method invoked by the event script is separately represented in an OED with a method type symbol. The OED or collection of OEDs that represent an application should show that the method invoked by the event script is available to the main object of the OED on which the event script appears. Thus, as will be seen from the discussion further below, the relevant method should be shown either in this OED linked to window symbol 501 or, alternatively, in the OED of another object from which the main object, window 501, of this OED has inheritance.

In a preferred embodiment of the invention, essentially everything else is shown outside of the big circle, including event scripts that are executed responsive to any events other than opening and closing of the main object of the diagram. Except for objects that are logically connected to another object by one of the three previously defined relationships that have their own symbols (namely, inheritance, data transfer, and remote link), all other relationships between objects in an OED (i.e., being assigned to another object or being defined within another object) preferably are represented by a simple line between the two objects. Generally, the relationship between the objects so linked will be self-explanatory simply based on the types of the two objects. Thus, the lines normally would not need an arrow at one end (or any other form of identification for that matter). However, if desired, an arrow may be drawn pointing toward the object within which the other object is defined or to which the other object is assigned.

A descriptive name should appear within the symbol representing each object shown in an OED, but the detailed properties of the object preferably is not set forth in the OED. Any actual, detailed description of an object that the architect feels is necessary may be disclosed in another document, such as by a simple text description. This should help keep the OEDs from becoming too complicated. However, text descriptions of the details of objects can be placed within the symbols if deemed desirable. Alternately, a reference to the textual description can be placed within the symbol, e.g., “See Document 3.41”. In yet another embodiment of the invention, in which the invention is implemented in a GUI by software, one may double click with one's pointer within the symbol in order to call up the textual description. The text description may appear in a separate pop-up window, for instance, like hyperlinking. Alternately, the text description may be called up via a mouse-over type retrieval. In an even further possible embodiment, the text description may be hidden text, which can be made visible in the same manner as the hidden comments feature provided in certain word processing programs such as IBM WordPro.

Next, all other objects defined within or assigned to the main object 501 preferably are drawn outside the large circle 503. These include a button symbol for each of the buttons, including a “NEW” button symbol 502, an “OPEN” button symbol 504, a “FLIGHTS” button symbol 506, a “CITIES” button symbol 508, a “PHONES” button symbol 510, a “PROGRAMS” button symbol 512, a “NEWS” button symbol 514, a “CALENDAR” button symbol 516, and a “HELP” button symbol 518. Since each button will cause something to happen, i.e., some piece of code to be executed, each button has associated with it an event script 520, 522, 524, 526, 528, 530, 532, 534, and 536, respectively, to represent the event and the script that will cause that button to invoke code. In this particular example, for each of the buttons, the event is a single mouse click over the corresponding button. This is represented in the script object's label by the word “click.” Furthermore, the method invoked thereby is identified by name in the label (e.g., “new file” for the new button). A description of the method invoked is not provided in the OED. As previously mentioned, it might be defined in a separate document or provided or referenced within the event script symbol by means of hidden text, hyperlinking, or otherwise.

In addition to the buttons discussed above, the FLIGHTS window 201a has a menu bar 221. A mouse click on each menu will invoke some other program module. Menu symbol 521 represents the menu bar 221 in the FLIGHTS window. If the architect thinks that the menus are sufficiently complex and/or non-standard, he or she may provide a separate, additional OED for the menu bar. Alternately, the application architect simply may provide a textual description of the menus that comprise the menu bar (which could be provided in a separate document or embedded within the OED by any of the previously described techniques). As an even further alternative, the architect may have, instead, decided to show each menu in the menu bar as a separate menu symbol directly within the OED 300a, rather than as a single menu symbol representing the entire menu bar as shown. Any of these options (as well as many other options) for illustrating the desired logic would be sufficient to describe the logic to a programmer.

There is more than one way to represent the business logic in accordance with the present invention. In fact, for most, if not all GUI's, there will probably be any number of ways that an architect or documentor could use any single embodiment of the present invention to represent the logic.

A menu object in an OED does not mean that the menu will open the object to which it is connected (window 201a in this case), but that, when the window (or other object) is open, the menu will be available within that object.

In addition to the objects, i.e., buttons and menus, that can be seen on the web page, there are a plurality of methods that are available in the window. They are represented by BUILD FLIGHTS method symbol 553, HANDLE PRINTING method symbol 555, GET AIRPORT BY CODE method symbol 557, VALIDATE CITY NAME method symbol 559, VALIDATE DATE AND TIME method symbol 561, VALIDATE AIRLINE method symbol 563, and GET DATABASE CONNECTION method symbol 565. As previously noted, linking a method object to a window object in an OED does not mean that the window will call that method. Rather, it means that the method is available in that window (as well as in any other window or other object that inherits the properties of that object). Thus, any event script assigned to that window or any other object within that window object can invoke that method.

Again, the functionality of the actual methods represented by the method symbols should be described in a separate document or by text hidden or otherwise embedded within the OED. However, by way of exemplification, for instance, the VALIDATE AIRLINE method might be a code module that checks the name of an airline entered by a user of the web page 200 to assure that the name corresponds to a known airline and, if it does not, inform the user of that fact and ask the user to enter a proper airline. As another example, the GET DATABASE method may connect to a database. A database connector is needed to build a list of potential flight plans for a user. The HANDLE PRINTING method may include, for instance, functions such as formatting the data, sending the data to a printer, monitoring the printer status, etc. The HANDLE PRINTING method object 389 is likely to be a complex object in the sense that it likely has many other objects assigned to or defined within it. Accordingly, an application architect may decide to prepare another OED to set forth the details of the HANDLE PRINTING object. If so, a reference to the other OED might be placed within the HANDLE PRINTING method symbol 555 in any of the manners previously mentioned.

Note that there is no button or menu item in the FLIGHTS window 201a that would likely be designed to invoke some of the methods shown in the diagram. For instance, the “validate airline” method most likely would be invoked in window 201b, for example, in response to a user tabbing out of one of the boxes shown to the right of the text AIRLINES after he or she enters an airline name in the box. Thus, the architect might reasonably have decided not to place the VALIDATE AIRLINE function symbol in the OED 600 for the FLIGHTS RESULTS window 201b, instead of the OED for the FLIGHTS window 201a. However, as anyone who has booked airline reservations online would probably recognize, there likely are several different web pages or windows in this web site that might need access to the VALIDATE AIRLINES method. In such a case, it is wise to make that method available in the FLIGHTS window since the FLIGHTS window will form part of most, if not all, of the web pages of the web site. Then, other windows of the web site can simply inherit the properties of the FLIGHTS window and, thus, have that method available to it. This is easily represented in the OEDs by showing inheritance of the properties of the FLIGHTS window in the OED for the other object by drawing an inheritance symbol between the FLIGHTS window symbol and the other object to illustrate that the other object is to inherit the properties of the FLIGHTS window. This is done in the OED 600 for the FLIGHTS RESULTS window 201b, for instance, as will be discussed in more detail below in connection with FIG. 6.

Turning now to FIG. 6, it is the OED 600 for FLIGHTS RESULTS window 201b. Accordingly, it comprises an appropriately labeled window symbol 601 in the center of a large circle 602, indicating that the FLIGHTS RESULTS window 601 is the main object of this particular diagram 600. The FLIGHTS RESULTS window inherits the properties of the FLIGHTS window 301, as demonstrated by drawing the symbol 501 for the FLIGHTS window within the circle 602 and connecting it to the flights results window with an inheritance symbol 603.

Upon opening and upon closing of the flights results window 601, other programs (methods or functions) are executed. Therefore, event script symbols 604 and 605 are drawn within the circle 602 and are appropriately labeled OPEN and CLOSE, respectively, to indicate the specific event that invokes the script. Once again, it is important to bear in mind that the event script symbol does not represent the method that is invoked responsive to the event, but just that the event (e.g., opening the window) causes execution of a script that invokes another program. Merely for explanatory purposes, for instance, upon opening of the flights results window 201b, script 604 might invoke a method that retrieves data from a database that is needed to build potential flight plans. The invoked method will be represented by a separate method symbol in this OED or an OED of another object from which the FLIGHTS RESULTS window inherits properties. In this case, the OPEN script 604 invokes the GET DATABASE CONNECTION method 565 shown in OED 500 for the FLIGHTS window (FIG. 5).

The FLIGHTS RESULTS window 201b includes 13 buttons. They are represented in the OED 600 by a “SEARCH” button symbol 650, a “CLOSE” button symbol 652, a “DETAILS” button symbol 654, a “RETURN” button symbol 656, a “BUILD” button symbol 658, an “ADD” button symbol 660, a “PRINT” button symbol 662, a “DEPART” button symbol 672, an “ARRIVE” button symbol 674, a “DIRECT” button symbol 668, a “CONNECT” button symbol 670, an “AIRLINES” button symbol 666, and a “SEE ALSO” button symbol 664. Since each button will cause something to happen, i.e., some piece of code to be executed, each button has associated with it an event script 651, 653, 655, 657, 659, 661, 663, 673, 675, 669, 671, 667, and 665, respectively, to represent the event which will cause that button to invoke code. In this particular example, the event is a single mouse click for each button. The actual function performed by the button is not shown in the OED and, as previously mentioned, might be defined in a separate document, such as a text document. Alternately, also as previously discussed, a description may be provided or referenced within the button symbol by means of hidden text, hyperlinking, or otherwise.

The OED 600 represents the five text boxes of FLIGHTS RESULTS window 200b with general symbols, namely “FROM” symbol 680, “TO” symbol 682, “TIME” symbol 684, “AIRLINES” symbol 686, and “DATE” symbol 688, all of which are static objects. All of those text boxes have scripts associated with them, represented by script symbols 681, 683, 685, 687, and 689, respectively. The script symbol labels disclose the event that will cause the script to be executed and the name of the method invoked by the script. Thus, the word “deselect” appears within the script symbols 681, 683, 685, 687, 689 to indicate that the corresponding script is executed when the particular box is “deselected” by the user. In this context, “deselect” refers to the user exiting the corresponding text box by hitting the TAB key (e.g., presumably after typing text in the box, such as typing the name of a destination airport or city in the “TO” box). Merely for purposes of clarity, the methods invoked with each of these scripts might be logic that determines if the text string entered in the corresponding text box is valid. For example, in the DATE box, if the date must be typed in using the form mm/dd/yyyy, the script will invoke a method that checks that the typed text is a real date (e.g., 11/27/2003) and will flag as incorrect text that does not meet the specified criteria (e.g., 13/33/2001, which comprises a non-existent month, a non-existent date and a year that is in the past, all three of which are clearly erroneous).

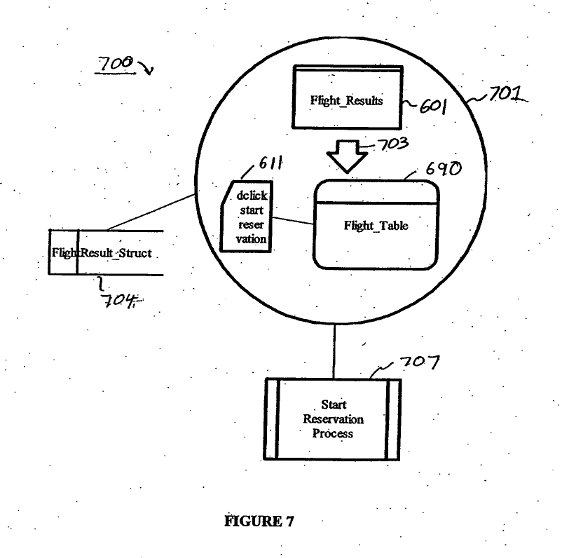

Frame 290 in FIGS. 2 and 4 is represented by frame symbol 690 in the OED 300b of FIG. 6. This is the frame in which flight plan records that are built responsive to the query parameters entered by the user in the aforementioned text boxes in window 201b will be displayed. Frame object 690 is a somewhat complex object and, therefore, has its own OED, which is shown in FIG. 7 and will be discussed in detail further below. However, this OED shows some details about frame object 690. Specifically, it shows that an event, namely, a double mouse click (termed “dclick” in the diagrams) over a particular flight plan record 291 listed in the frame will invoke an event script. This is represented in the OED by event script symbol 611. Event script 611 will invoke a method called START RESERVATIONS. THE START RESERVATIONS method is not represented by the event script symbol 611. Nevertheless, by way of explanation, that method would, for example, open a RESERVATIONS window (shown in FIG. 7, which is discussed in detail below) within which the user can book the selected flight.

Frame object 690 is a somewhat complex object that might warrant creation of a separate OED for that object. Accordingly, FIG. 7 is an OED 700 for frame object table 690. The frame 690 is, therefore, shown within a circle 701 to show that it is the main object of this diagram. It inherits the properties of the FLIGHTS RESULTS window object 601, which is represented in the OED 700 by drawing the FLIGHTS RESULTS window symbol 601 within the circle 701 and connecting it to the frame symbol 690 with an inheritance symbol 703. The event script symbol 611 is shown again in OED 700, within the circle 701. The method that is invoked by event script 611 is represented by method symbol 707, labeled START RESERVATION PROCESS, which is the process that will, among other things, open the RESERVATIONS window.

The fact that flight plan records 291 will appear within the frame 290/690 is represented by drawing a suitably labeled data structure symbol 704 outside of the circle 701 and connecting it to the circle by a line. The definition of the flights results data structure 704 is not shown in this diagram, but preferably, is disclosed in separate documentation. By way of example, the data that comprises a flight results record would include (1) days of departure, (2) flight number, (3) departing time, (4) arrival time, (5) departing city, (6) arrival city, (7) class code, (7) number of stops, and (8) flight duration.

The web page 200 is a part of a larger system, i.e., a web site that includes several other pages. Thus, while one may choose to represent just web page 200 using the present invention, an architect building a website for booking flights or an individual documenting such software most likely would use the present invention to represent the entire website. In that case, he or she would create a top-level OED representing the entire website. An exemplary top-level, system OED 800 for a flight booking website including page 200, among others, is shown in FIG. 8.

As shown in OED 800 of FIG. 8, the overall website application is represented by an appropriately labeled system symbol 801 drawn within a circle 802. All of the windows that can form part of the various web pages of the website are drawn and are connected to the circle 802 by lines. These windows include the main FLIGHTS window 201/501 and the FLIGHTS RESULTS window 201b/601 previously described in detail. They also include the previously mentioned, but not shown, RESERVATIONS window 804 within which a user of the website may actually book reservations. In addition there is an AIRLINE PHONES window represented by window symbol 806, which, for example, will display the telephone numbers for the various airlines and is opened in response to the user clicking on the PHONES button 210/510 in the main flights window 201a. There also is a CALENDAR window, represented by window symbol 808, which will display a calendar that the user can consult to figure out his or her desired flight dates. This window is opened in response to the user clicking on the CALENDAR button 216/516 in the main FLIGHTS window 201a/501. There also is a HELP window, represented by window symbol 810, that offers a variety of help functions to the user. This window is opened in response to the user clicking on the HELP button 218/518 in the FLIGHTS window. A NEWS window, represented by window symbol 812, is opened in response to the user clicking on the NEWS button 214/514 in the FLIGHTS window 201a/501 and provides current news articles or links to news related websites. A CITIES window, represented by window symbol 814, shows a list of cities and may have functionality to help users choose cities to fly to and/or from, such as searching cities by country or time zone. That window is opened in response to the user clicking on the CITIES button 208/508 in the FLIGHTS window. A REWARDS PROGRAM window represented by window symbol 816, shows information on rewards programs offered by the various airlines and is opened in response to the user clicking on the PROGRAMS button 212/512 in the main FLIGHTS window.

Also shown in OED 800 is a method 809 for validating the user's password. This is shown in this OED because it is a program that the architect decided was to be universally available to the entire system website.

In addition, all of the flight information that is necessary to allow users to book flights must be obtained from an appropriate resource. In actuality, there is a service available on the Internet (herein termed HUB) that provides all current available flight information for essentially all airlines worldwide, including seat availability, seat price, etc. Thus, a data transfer symbol 811 is shown connected by a line to the circle 802 to represent the fact that a data transfer of this information from the remote HUB website is needed to access this information. In addition, the website will need to access software on the remote HUB website in order to download this information. This is represented in the diagram by showing a remote link symbol 813 connected to an application symbol 815 labeled MAIN FLIGHTS HUB APPILCATION.

Also shown is a database 817. This represents the fact that the website will also access information from a local database. Particularly, some of the information downloaded from the HUB website will be cached on a local database (and updated periodically) in order to speed access to the necessary data. For instance, the list of existing flights will not change often, and, therefore, might be cached on the local database. On the other hand, when actually booking a reservation, it will likely be necessary to access the HUB website contemporaneously in order to determine if seats available on a selected flight and the price of the seat since that information can change by the minute or second.

Each window shown in OED 800 of FIG. 8 should have its own OED (most likely several OEDs, as was the case for FLIGHTS RESULTS window 201b) that sets forth the details of that window. However, we have not reproduced them all for this specification.

When an overall application system is represented in a plurality of interrelated OEDs (as will typically be the case), it may be advisable to include as part of the object symbol labels references disclosing the other diagrams within which that object appears. Even more preferably, such a reference also should disclose whether the other OEDs show the object in more detail or less detail (at a higher or lower level of abstraction) and/or whether the object is the main object of the referenced OED.

As previously noted, rules may vary depending on the particular embodiment of the invention. However, there are some rules and recommendations that will generally be beneficial to follow. For instance, any object that contains other objects, unless very simple, should have its own OED. Also, it is generally advisable to represent inheritance in the diagrams. Further, static objects do not necessarily need to be represented in the diagrams given that they typically are simple. Particularly, they do not execute anything or have any events or business rules assigned to them. Their natures often will be self-explanatory from the remaining elements of an OED and may require no further exposition to enable a programmer to write the corresponding code.

Every menu object should be represented in the highest level object diagram since many menus often are available in most, if not all, windows of an application.

In an OED, an event script should be drawn linked to the object that invokes it rather than to the main object.

All method objects should be shown in an OED. If a method object appears in a window OED (i.e., the main object of the OED is a window), it means that the method is local to that window. On the other hand, if a method object is defined in the application/system OED, the method is global and can be used in any window. Unlike event scripts, it is advisable to connect method objects to the main object of the OED rather than the object that invokes it.

Record objects, general objects, data transfer objects, and database objects generally will not need to have their own diagram. Often, they may just be represented in the highest level object diagram.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

1. A method for graphically representing object oriented programming logic, the method comprising the steps of:
(1) providing a plurality of different symbols for use in a diagram of object oriented programming logic, each different symbol representing a different type of object;
(2) selecting an object as a main object of the logic to be represented in the diagram;
(3) drawing a symbol corresponding to the main object and labeling the symbol with a label descriptive of the object's features so that it is distinguishable from other symbols of the same object type;
(4) for each object assigned to or defined within the main object, drawing a symbol corresponding to that object and labeling the symbol with a label descriptive of the object's features; and
(5) drawing a line between each object drawn in step (4) and another object in the graphical representation to which it is assigned or within which it is defined.

2. The method of claim 1 further comprising the step of:
(6) providing a plurality of additional symbols for use in the diagram, each of the additional symbols representing an object oriented programming element other than an object.

3. The method of claim 1 further comprising the step of:
(7) graphically denoting the main object in the diagram by drawing another symbol around the symbol for the main object.

4. The method of claim 3 wherein step (6) comprises drawing a circle completely enclosing the symbol of the main object.

5. The method of claim 1 wherein the labels comprise text.

6. The method of claim 1 wherein step (5) comprises drawing the line between the object defined in step (4) and another object it is most directly assigned to or is most directly defined within.

7. The method of claim 1 wherein the method is used to document software.

8. The method of claim 1 wherein the method is used to prepare a program specification.

9. The method of claim 1 further comprising the step of:
(8) repeating steps (1)-(5) to prepare a plurality of separate diagrams corresponding to separate parts of an overall application and wherein a first object is the main object appearing in at least a first one of the diagrams and is not a main object appearing in at least a second one of the diagrams.

10. The method of claim 9 wherein the second diagram does not disclose objects assigned to and defined within the first object and the first diagram does disclose objects assigned to and defined within the first object.

11. The method of claim 10 wherein the second diagram is an application-level representation disclosing an overall software system.

12. The method of claim 10 wherein the label for the first object in the second diagram identifies the first diagram as disclosing further details of the first object.

13. The method of claim 1 wherein the symbols representing different object types include:
a first symbol for representing objects that are application type objects;
a second symbol for representing objects that are window type objects;
a third symbol for representing objects that are class type objects;
a fourth symbol for representing objects that are event script type objects; and
a fifth symbol for representing objects that are method type objects.

14. The method of claim 1 wherein the symbols representing different object types include:
a first symbol for representing objects that are application type objects;
a second symbol for representing objects that are window type objects;
a third symbol for representing objects that are class type objects;
a fourth symbol for representing objects that are event script type objects; and
a fifth symbol for representing objects that are method type objects.
and wherein the symbols representing additional program elements include:
a sixth symbol for representing data transfer;
a seventh symbol for representing databases;
an eighth symbol for representing remote links; and
a ninth symbol for representing inheritance.

15. The method of claim 14 wherein the sixth, eighth, and ninth symbols are drawn connecting two other object symbols.

16. The method of claim 14 wherein the symbols representing different object types further include;
a tenth symbol for representing objects that are menu type objects;
a eleventh symbol for representing objects that are frame type objects;
an twelfth symbol for representing objects that are button type objects;
a thirteenth symbol for representing objects that are data structure type objects; and
a fourteenth symbol for representing objects that are not one of the other object types.

17. The method of claim 13 further comprising the step of:
(9) providing in a separate document a description of the logic to be performed responsive to an event script.

18. The method of claim 13 wherein the fourth symbol representing event script type objects is drawn connected to another object that directly executes the event script corresponding to the event script symbol.

19. The method of claim 13 wherein the fifth symbol representing method type objects is drawn connected to the main object of the diagram and represents that the object is available within that main object and does not represent that the main object invokes it.

20. The method of claim 1 wherein the method is implemented via a computer program, and wherein step (1) comprises providing a graphical user interface in which a user is presented with a pallet containing the symbols and wherein steps (3) and (4) comprise dragging and dropping the symbols from the pallet into a work area.

21. The method of claim 1 wherein the method is implemented via a computer program, and wherein step (1) comprises providing a graphical user interface in which a user is presented with a pallet containing the symbols and wherein steps (3) and (4) comprise dragging and dropping the symbols from the pallet into a work area, and wherein the labels comprise text and further wherein at least some of the text labels are hidden text that can be made to appear in the graphical representation via an action taken by a user.

22. A computer readable product embodied on computer readable media readable by a computing device for enabling a user to generate a graphical representation of object oriented programming logic, the product comprising:
first computer executable instructions that provide a graphical user interface in which a user is presented with a plurality of different symbols for use in developing a graphical representation of object oriented programming logic, each different symbol representing a different type of object in object oriented programming;
second computer executable instructions that enable the user to drag and drop symbols into a workspace and label the symbol with a label descriptive of the object's features; and
third computer executable instructions that enable the user to draw lines between objects in the workspace.

23. The computer readable product of claim 22 further comprising:
fourth computer executable instructions that enable the user to graphically denote the main object in the diagram by drawing another symbol around the symbol for the main object.

24. The computer readable product of claim 22 further comprising:
fifth computer executable instructions that enable the user to denote one and only one object in the workspace as a main object.

25. The computer readable product of claim 24 wherein the fourth computer executable instructions comprise instructions enabling the user to enclose the one and only one object within a circle.

26. The computer readable product of claim 22 wherein the labels are text labels.

27. The computer readable product of claim 22 further comprising:
sixth computer readable instructions that enable the user to prepare a plurality of the diagrams corresponding to separate parts of an overall application and further comprising computer readable instructions for enabling the user to specify relationships between individual ones of the diagrams.

28. The computer readable product of claim 27 wherein the sixth computer readable instructions comprise instructions that enable the user to including references associated with symbols in one diagram identifying at least one other diagram within which the object represented by that symbol also appears.

29. The computer readable product of claim 28 wherein the sixth computer readable instructions comprise instructions that enable the user to specify in a first one of the diagrams the nature of the relationship of the representation of the object in the first diagram relative to the representation of the object in a second diagram, wherein the relationship between the object as represented in the first and second diagrams is selected from the group comprising: (1) the second diagram discloses additional details about the object in the first diagram; (2) the second diagram shows the object in a more abstract context than the first diagram; and (3) the object is the main object of the second diagram.

30. The computer readable product of claim 22 wherein the symbols representing different object types include:
a first symbol for representing objects that are application type objects;
a second symbol for representing objects that are window type objects;
a third symbol for representing objects that are class type objects;
a fourth symbol for representing objects that are event script type objects; and
a fifth symbol for representing objects that are method type objects.

31. The computer readable product of claim 24 wherein the symbols representing different object types include:
a first symbol for representing objects that are application type objects;
a second symbol for representing objects that are window type objects;
a third symbol for representing objects that are class type objects;
a fourth symbol for representing objects that are event script type objects; and
a fifth symbol for representing objects that are method type objects.
and wherein the additional symbols representing additional program elements include:
a sixth symbol for representing data transfers;
a seventh symbol for representing databases;
an eighth symbol for representing remote links; and
a ninth symbol for representing inheritance.

32. The computer readable product of claim 31 further comprising:
seventh computer executable instructions that restrict the user to using the sixth, eighth, and ninth symbols to connect two other object symbols.

33. The computer readable product of claim 30 wherein the symbols representing different object types further include;
a tenth symbol for representing objects that are menu type objects;
an eleventh symbol for representing objects that are frame type objects;
a twelfth symbol for representing objects that are button type objects;
a thirteenth symbol for representing objects that are data structure type objects; and
a fourteenth symbol for representing objects that are not one of the other object types.

34. The computer readable product of claim 30 further comprising:
eighth computer executable instructions that enable the user to providing in a separate document a description of the logic to be performed responsive to an event script.

35. The computer readable product of claim 22 further comprising:
ninth computer executable instructions that enable the user to insert hidden text associated with symbols in the workspace that can be made to appear in the workspace responsive to an action taken by a user.
